(19) United States
(12) Patent Application Publication
(10) Pub. No.: US 2026/0214311 A1
(43) Pub. Date: Jul. 23, 2026

(54) CAMERA MODULE AND ELECTRONIC DEVICE HAVING THE SAME

(71) Applicant: Rayprus Technology (Foshan) Co., Ltd., Foshan (CN)

(72) Inventors: HUI YANG, Foshan (CN); Chia-Feng Chang, New Taipei (TW); Jyun-Hong Lu, New Taipei (TW); Mei-Lien Chou, New Taipei (TW); Ying Wang, Foshan (CN)

(21) Appl. No.: 19/095,311

(22) Filed: Mar. 31, 2025

(30) Foreign Application Priority Data
Jan. 23, 2025 (CN) 202520168712.8

(51) Int. Cl. H04N 23/54; H04N 23/51; H04N 23/55

(52) U.S. Cl. CPC H04N 23/54; H04N 23/51; H04N 23/55

(57) ABSTRACT

A camera module includes a substrate, a cover, and a first electronic component. A groove is defined by the substrate. The cover is arranged on the substrate and covers the groove. At least part of the first electronic component is received in the groove. An electronic device having the camera module is also provided.

### FIELD

The subject matter herein generally relates to a technical field of optical components, and in particular to a camera module and an electronic device having the camera module.

### BACKGROUND

With the development of thinning and miniaturization of electronic devices (such as laptops), the space size of camera modules in electronic devices is becoming smaller. The camera modules usually include a circuit board and electronic components arranged on the circuit board, while most of the electronic components are placed in a shielding cover to prevent potential damages caused by electrostatic discharges.

However, in some ultra-thin models, the height space inside the shielding cover is small, resulting in a limited number of electronic components which can be accommodated inside the shielding cover. When assembling the electronic components, in order to avoid interference between the electronic components and the shielding covers, it is necessary to select smaller sized electronic components or split the electronic components into multiple components for series and parallel connections. In addition to increasing costs, series and parallel connections will increase an use area on the circuit board, which is not easy to implement in miniaturized modules.

### BRIEF DESCRIPTION OF THE DRAWINGS

Implementations of the present disclosure will now be described, by way of embodiments, with reference to the attached figures.

FIG. 1 is a diagram illustrating a camera module according to an embodiment of the present disclosure.

FIG. 2 is an exploded view illustrating a camera module according to an embodiment of the present disclosure.

FIG. 3 is a cross-sectional view illustrating the camera module taken along III-III line in FIG. 1.

FIG. 4 is an enlarger schematic diagram illustrating a partial area IV of the camera module in FIG. 3.

FIG. 5 is a diagram illustrating an electronic device according to an embodiment of the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar components. It should be noted that references to “an” or “one” embodiment in this disclosure are not necessarily to the same embodiment, and such references mean “at least one.”

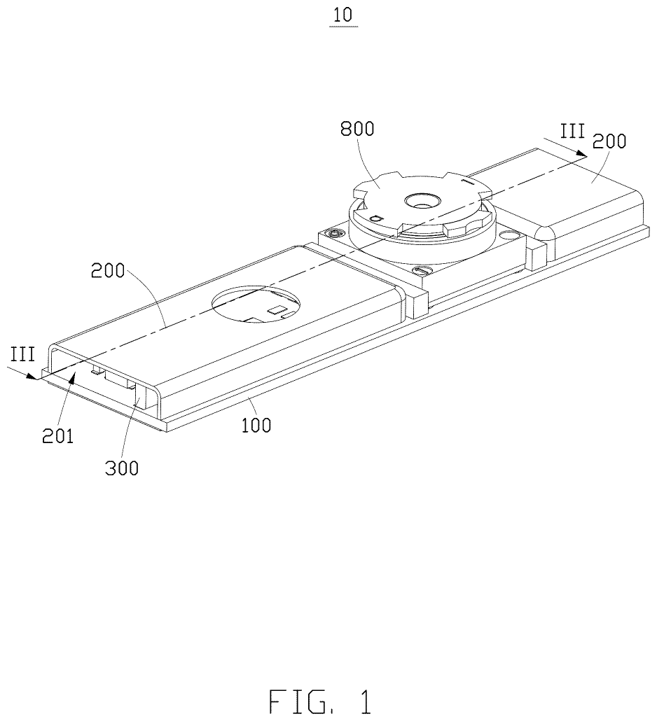

FIG. 1 illustrates an embodiment of a camera module 10. The camera module 10 includes a substrate 100, a cover 200, and a first electronic component 300. A groove 101 is defined by the substrate 100. The cover 200 is arranged on the substrate 100 and covers the groove 101. At least part of the first electronic component 300 is received in the groove 101.

By providing the groove 101 on the substrate 100, at least part of the first electronic component 300 can be embedded in the groove 101, which efficiently utilizes the space that might otherwise be wasted and reduces the overall height of the camera module 10, so that the camera module 10 is more suitable for ultra-thin devices ultra-thin devices. By placing at least part of the first electronic component 300 in the groove 101, larger-sized electronic components can be used without being limited to smaller electronic components or having to be split into series and parallel, thereby increasing the flexibility and performance of the design. The optimized space design may reduce the need for complex and expensive series-parallel designs, thereby reducing production costs and material usage.

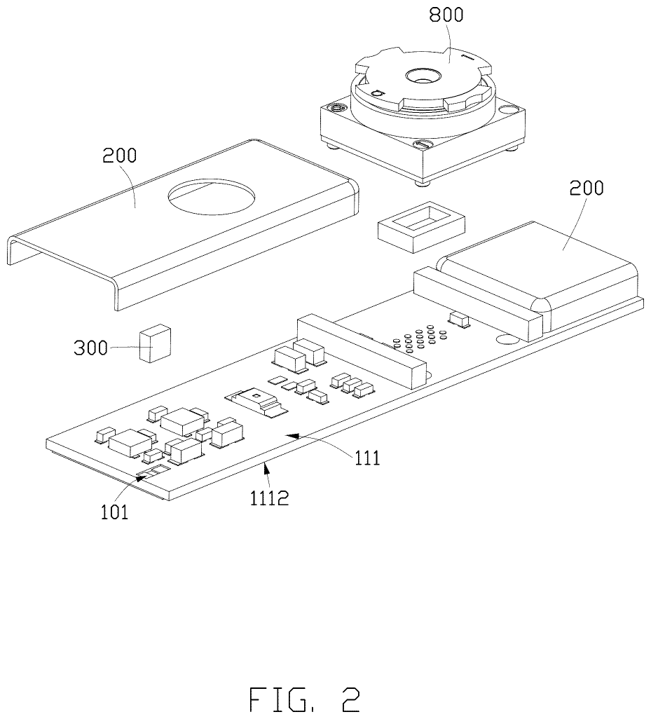

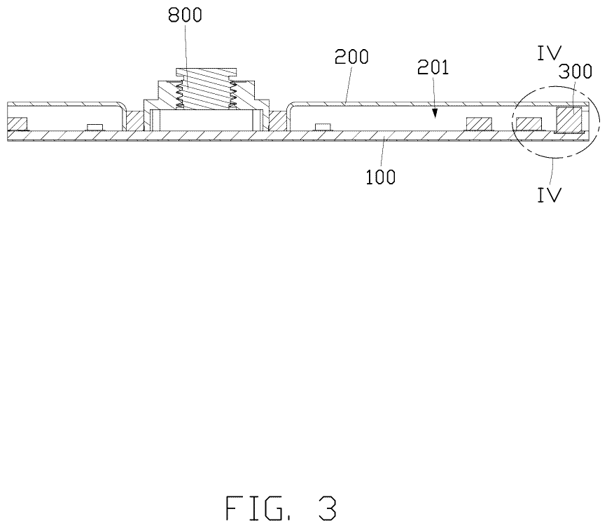

Referring to FIGS. 2 and 3, in at least one embodiment, the substrate 100 includes an upper surface 111 and a lower surface 112 facing away from the upper surface 111. The groove 101 is recessed from the upper surface 111 towards the lower surface 112, and the cover 200 is located on the upper surface 111 and a shielding cavity 201 is enclosed by the cover 200 and the upper surface 111. The groove 101 is communicated with the shielding cavity 201. The first electronic component 300 extends into the shielding cavity 201 from the groove 101. Since the first electronic component 300 can extend into the shielding cavity 201, the vertical space utilization of the overall structure is more efficient, which effectively addresses the strict space requirements in ultra-thin devices. Placing some electronic components in the groove 101 and extending them into the shielding cavity 201 reduces the need for component splitting and series and parallel design, thereby simplifying the assembly process and lowering the risk of assembly errors. The above design supports the integration of more functions and enhances overall performance while maintaining miniaturization, thereby enabling more technological innovations and applications in electronic devices.

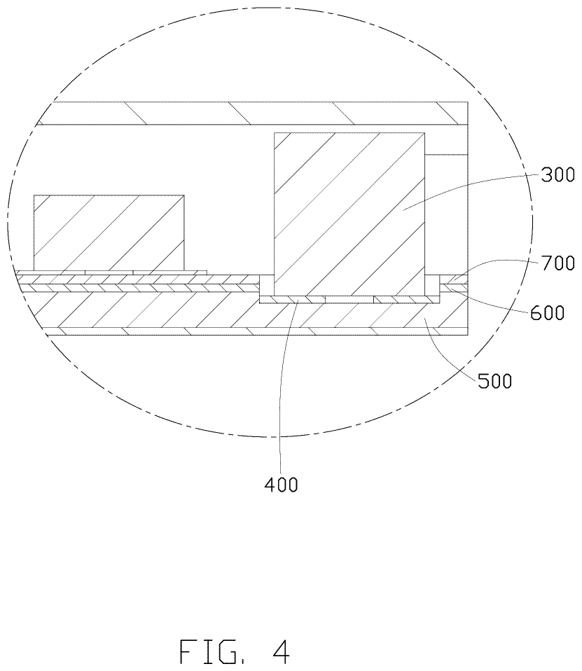

Referring to FIG. 4, in at least one embodiment, the groove 101 may do not penetrate the lower surface 112. The non-penetrating design of the groove 101 simplifies the production and processing procedures, reduces manufacturing costs and technical difficulties, and improves the yield rate. The non-penetrating design can better cooperate with the cover 200 for sealing, thereby enhancing the shielding effect of the space and improving the anti-interference capability of the device. The non-penetrating design of the groove 101 also provides strong support for the first electronic component 300.

Referring to FIGS. 2 and 3, in at least one embodiment, the camera module 10 may further include a second electronic component 301. A height of the second electronic component 301 is less than the height of the first electronic component 300, and the second electronic component 301 is fixed on the upper surface 111. When there are two types of electronic components, namely the thicker first electronic component 300 and the thinner second electronic component 301, only the thicker first electronic component 300 needs to be placed in the groove 101.

Referring to FIG. 4, in at least one embodiment, at least one solder pad 400 may be provided on a bottom wall of the groove 101, and the first electronic component 300 is electrically connected to the substrate 100 through the solder pad 400. By setting the solder pad 400 on the bottom wall of the groove 101, it ensures that the first electronic component 300 can be firmly connected through the solder pad 400, thereby improving the reliability of the electrical connection and reducing the risk of poor contact. Since the first electronic component 300 is directly fixed to the bottom of the groove 101 through the solder pad 400, it avoids the need for other support or connection structures, so that the installation space is further saved and the requirements of ultra-thin design is meet. The position and the shape of the solder pad 400 can be flexibly adjusted according to different types and requirements of the first electronic component 300 and the second electronic component 301, thereby providing more design freedom.

Referring to FIG. 4, in at least one embodiment, a depth of the groove 101 may be in a range of 0.1 mm to 0.2 mm.

Referring to FIG. 4, in at least one embodiment, the substrate may include a base layer 500, a circuit layer 600, and a solder mask layer 700 stacked in that sequence. The cover 200 is located on a side of the solder mask layer 700 facing away from the base layer 500. The solder mask layer 700 is used to cover at least part of the circuit layer 600. The groove 101 penetrates through the solder mask layer 700, the circuit layer 600, and part of the base layer 500. The above structure may prevent accidental short circuits and environmental influences (such as moisture, etc.), protect the stability and the safety of the circuit, and increase the durability of the substrate 100. In order that the excessively high first electronic component 300 can be fixed in the groove 101 on the substrate 100 and located in the shielding cavity 201 of the cover 200, part of the substrate 100 is removed to form the groove 101, thereby sinking the first electronic component 300 relative to the upper surface 111 of the substrate 100 to prevent the excessively high first electronic component 300 from colliding with the cover 200 or prevent the first electronic component 300 from being unable to be placed in the shielding cavity 201. In at least one embodiment, the reasonable design of the base layer 500, the circuit layer 600, and the solder mask layer 700 may further include increasing the adhesion between layers, so that the physical and electrical stability of the overall substrate 100 may be improved.

Referring to FIGS. 1 to 4, in at least one embodiment, the camera module 10 may further include a lens holder 800 and a lens 801 located in the lens holder 800. The lens holder 800 is fixed to the substrate 100. The number of the covers 200 is two, and the covers 200 are located on opposite sides of the lens holder 800. The direct fixation design of the lens holder 800 simplifies the assembly process, reduces assembly steps, and improves production efficiency. The lens holder 800 being located on one side of the cover 200 helps optimize the overall space utilization, and allows for a rational layout of electronic components, the lens holder 800, and other components, thereby avoiding design inflexibility due to space constraints. This design helps integrate the lens 801 and its corresponding electronic components more closely, which reduces the overall space occupied by the camera module 10 and meets the market demand for smaller devices.

Referring to FIG. 2, in at least one embodiment, a material of the cover 200 is iron. Iron is a good conductor and has excellent shielding effects against electromagnetic waves and electrostatic discharge (ESD), which effectively protects internal electronic components from external interference. Iron has high mechanical strength, which provides good protection for the internal structure and prevents damage to the electronic components from physical shock and external environmental.

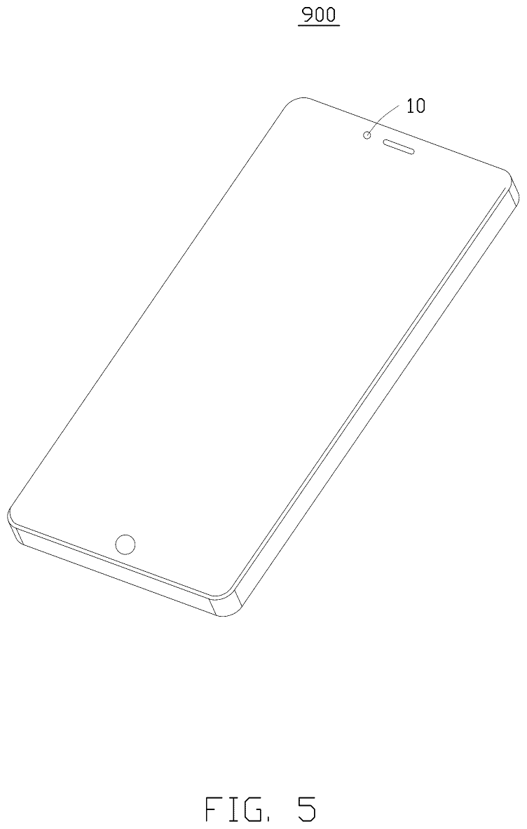

FIG. 5 illustrates an embodiment of an electronic device 900. The electronic device 900 includes the camera module 10. Integrating the camera module 10 into the electronic device can improve its image acquisition and shooting capabilities, especially in ultra-thin devices, so that the demand for high image quality can be meet and the user experience can be improved. The structure of the camera module 10 is optimized to help the overall electronic device become lighter and thinner, so as to adapt to the trend of miniaturization of the consumer electronic products and meet the needs of the market and users.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A camera module comprising:
a substrate comprising a groove;
a cover, wherein the cover is arranged on the substrate and covers the groove; and
a first electronic component, wherein at least part of the first electronic component is received in the groove.

2. The camera module of claim 1, wherein the substrate further comprises an upper surface and a lower surface facing away from the upper surface, the groove is recessed from the upper surface towards the lower surface, and the cover is located on the upper surface and a shielding cavity is enclosed by the cover and the upper surface, the first electronic component extends into the shielding cavity from the groove.

3. The camera module of claim 2, wherein the groove does not penetrate the lower surface.

4. The camera module of claim 2, wherein the camera module further comprises a second electronic component fixed on the upper surface, a height of the second electronic component is less than the height of the first electronic component.

5. The camera module of claim 2, wherein at least one solder pad is arranged on a bottom wall of the groove, the substrate electrically connects to the first electronic component through the at least one solder pad.

6. The camera module of claim 1, wherein a depth of the groove is in a range of 0.1 mm to 0.2 mm.

7. The camera module of claim 1, wherein the substrate further comprises a base layer, a circuit layer, and a solder mask layer stacked in said sequence, the cover is located on a side of the solder mask layer facing away from the base layer, at least part of the circuit layer is covered by the solder mask layer, the groove penetrates the solder mask layer, the circuit layer and a part of the base layer.

8. The camera module of claim 1, wherein the camera module further comprise a lens holder and a lens arranged in the lens holder, the lens holder is fixed on the substrate, the camera module further comprises another cover, the covers are located on opposite sides of the lens holder.

9. The camera module of claim 1, wherein the cover is made of iron.

10. An electronic device comprising:
a camera module comprising:
a substrate comprising a groove;
a cover, wherein the cover is arranged on the substrate and covers the groove; and
a first electronic component, wherein at least part of the first electronic component is received in the groove.

11. The electronic device of claim 10, wherein the substrate further comprises an upper surface and a lower surface facing away from the upper surface, the groove is recessed from the upper surface towards the lower surface, and the cover is located on the upper surface and a shielding cavity is enclosed by the cover and the upper surface, the first electronic component extends into the shielding cavity from the groove.

12. The electronic device of claim 11, wherein the groove does not penetrate the lower surface.

13. The electronic device of claim 11, wherein the camera module further comprises a second electronic component fixed on the upper surface, a height of the second electronic component is less than the height of the first electronic component.

14. The electronic device of claim 11, wherein at least one solder pad is arranged on a bottom wall of the groove, the first electronic component is electrically connected to the substrate through the at least one solder pad.

15. The electronic device of claim 10, wherein a depth of the groove is in a range of 0.1 mm to 0.2 mm.

16. The electronic device of claim 10, wherein the substrate further comprises a base layer, a circuit layer, and a solder mask layer stacked in that sequence, the cover is located on a side of the solder mask layer facing away from the base layer, at least part of the circuit layer is covered by the solder mask layer, the groove penetrates the solder mask layer, the circuit layer and part of the base layer.

17. The electronic device of claim 10, wherein the camera module further comprise a lens holder and a lens arranged in the lens holder, the lens holder is fixed on the substrate, the camera module further comprises another cover, the covers are located on opposite sides of the lens holder.

18. The electronic device of claim 10, wherein the cover is made of iron.
